(19) United States
(12) Patent Application Publication
(10) Pub. No.: US 2014/0077931 A1
(43) Pub. Date: Mar. 20, 2014

(54) VEHICLE REMOTE CONTROL KEY, AND APPARATUS AND METHOD OF VARIABLY CONTROLLING OUTPUT OF TRANSMISSION RADIO SIGNAL

(71) Applicant: HYUNDAI MOTOR COMPANY, Seoul (KR)

(72) Inventor: Seong Hwan Cho, Hwaseong (KR)

(73) Assignee: Hyundai Motor Company, Seoul (KR)

(21) Appl. No.: 13/711,240

(22) Filed: Dec. 11, 2012

(30) Foreign Application Priority Data
Sep. 19, 2012 (KR) 10-2012-0104192

(51) Int. Cl. G05B 1/01

(52) U.S. Cl. CPC G05B 1/01
USPC 340/5.72

(57) ABSTRACT

Provided are a vehicle remote control key, and a system and a method of remotely controlling a vehicle, the system and method being capable of variably outputting a transmission radio signal so that a remote control distance is controlled for each control target to be operated. In particular, a method of remotely controlling opening or closing of an additional control target of the vehicle through the remote control key includes a function button for remotely controlling a door of the vehicle, the method including: detecting operation of the function button; and transmitting a signal related to the opening or closing of the additional control target with an output set according to an operation time of the function button.

### CROSS-REFERENCE TO RELATED APPLICATION

This application claims priority to and the benefit of Korean Patent Application No. 10-2012-0104192 filed in the Korean Intellectual Property Office on Sep. 19, 2012, the entire contents of which are incorporated herein by reference.

### BACKGROUND OF THE INVENTION

(a) Field of the Invention

The present invention relates to a vehicle remote control key, and a system and a method of remotely controlling a vehicle, and more particularly, to a system and a method of remotely controlling a vehicle capable of variably outputting a transmission radio signal so that a remote control distance is controlled for each control target to be operated.

(b) Description of the Related Art

As is well known, a door remote control apparatus capable of locking or unlocking a door of a vehicle remotely from the vehicle has been applied to many vehicles in order to provide convenience for a driver.

The door remote control apparatus includes a remote control key possessed and carried by a driver and a door control module for receiving a door control signal, for example, that enables door locking and door unlocking, from the remote control key to lock or unlock the door.

The remote control key may transmit the door control signal for locking or unlocking the door of the vehicle separated within a predetermined distance, and the door control module may use, for example, a radio frequency (RF) of an ultra high fidelity (UHF) band, in order to receive the door control signal.

Recently, a door remote control apparatus has been developed as a smart key wireless control apparatus (or a “smart key system”) capable of controlling an antitheft function (passive entry and passive start: PEPS) by wirelessly performing authentication of a driver and wireless starting (smart starting authentication-immobilizer operation), as well as controlling the door. The smart key system may use a low frequency (LF) for authentication of a smart key, and use a radio frequency (RF) of an ultra high frequency (UHF) band for vehicle control. An example of a vehicle smart key system is disclosed in Korean Patent Registration No. 10-1141807.

Further, the door remote control apparatus may be upgraded to a “multifunctional” vehicle remote control system capable of remotely controlling a window and a sunroof, as well as remotely controlling the door. Here, the term “multifunctional” is used to distinguish this type of vehicle remote control system from a general door remote control apparatus for convenience.

Hereinafter, an apparatus capable of remotely controlling a window, a sunroof, and/or other control targets (for example, a trunk and a starting motor) equivalent in operation to the door, the window, and the sunroof, as well as remotely controlling the door, will be referred to as a vehicle remote control system.

A remote control key for remotely controlling a vehicle may be variously called a smart key, a FOB key, a remote starting key, and the like. Accordingly, a vehicle remote control key encompasses any of the smart key, the FOB key, the remote starting key, and the like using wireless communication technology.

However, in the vehicle remote control system, when a window or a sunroof is remotely controlled so as to be opened/closed, there is a limitation in an operation distance for safety assurance. That is, it may be regulated by law that it is possible to remotely control the window and the sunroof within a maximum of 10 m in an open space in which a view is secured and a maximum of 7 m in a place in which a view is shielded from the vehicle, and in other cases, the window and the sunroof cannot be remotely controlled for safety reasons.

However, the door remote control apparatus should be capable of remote operation from a longer distance, such as a minimum of 30 m, so that there is a problem in a vehicle remote control system that operates from such a longer distance, in particular, for remotely controlling the window and the sunroof to which safety regulations are applied.

According to conventional technology, when a door lock button provided at a remote control key for remote control is pressed for a first set time (for example, a time period shorter than two seconds), a door is locked, when the door lock button provided at the remote control key for remote control is pressed for a second set time (for example, a time period of two seconds or longer), a window and/or a sunroof is closed, when a door unlock button is pressed for a third set time (for example, a time period of shorter than two seconds), the door is unlocked, and when the door unlock button is pressed for a fourth set time (for example, a time period of two seconds or longer), the window and/or the sunroof is opened. In this case, the window and the sunroof are operated when the door lock button or the door unlock button are pressed for more than a set time (for example, two seconds) at a door locking and unlocking available distance (for example, a minimum of 30 m), thereby potentially violating safety regulations.

Accordingly, in order to solve the above-described problems encountered with conventional technology, there is a problem in that a remote control distance of a door must comply with a control distance of a window and a sunroof to which safety regulations are applied, and a module for remotely controlling a door should be separately configured from a module for remotely controlling the window and the sunroof inside the apparatus, thus increasing production costs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vehicle remote control key, and a system and a method for remotely controlling a vehicle having an advantage of satisfying applicable safety regulations in a cost-effective manner by variably controlling an output of a transmission radio signal according to an operation mode so as to transmit the output of the transmission radio signal up to a minimum control distance (long distance) (for example, a minimum of about 30 m) at which a door can be locked or unlocked or to transmit the output of the transmission radio signal only up to a maximum control distance (short distance) (for example, a maximum of about 7 to 10 m) at which opening or closing of a window and a sunroof that is subject to safety regulations can be controlled.

An exemplary embodiment of the present invention provides a method of remotely controlling opening or closing of an additional control target of a vehicle through a remote control key including a function button for remotely controlling a door of the vehicle, the method including: detecting, by a controller, operation of the function button; and transmitting, by the controller, a signal related to the opening or closing of the additional control target with an output set according to an operation time of the function button.

Another exemplary embodiment of the present invention provides a method of remotely controlling opening or closing of an additional control target in addition to a door of a vehicle through a remote control key provided with a lock button for remotely locking a door of the vehicle and an unlock button for remotely unlocking the door of the vehicle, the method including: detecting, by a controller, an operation of the lock button or the unlock button; when the operation of the lock button or the unlock button is detected, transmitting a radio signal including a unique identification code related to a door operation corresponding to the operated button among the opening and the closing of the door with a set high output; and when the manipulation time of the operated lock button or unlock button is equal to or longer than a set time, transmitting the radio signal including the unique identification code corresponding to the operated button in relation to the additional control target with a set low output lower than the set high output.

The set high output may be an output having a size by which the radio signal is transmitted to a set long distance.

The set low output may be an output by which the radio signal is transmitted to a set short distance shorter than the set long distance.

The set long distance may be set to be at least two times larger than the set short distance.

The unique identification code corresponding to the operated button may be an identification code related to a close operation of the additional control target when the operated button is the lock button, and an identification code related to an open operation of the additional control target when the operated button is the unlock button.

The additional control target may include at least one of a sunroof, a window, and a roll blind of the vehicle. In particular, the additional control target can be any control target of the vehicle except the door itself, and one or more additional control targets may be controlled according to the present invention.

Yet another exemplary embodiment of the present invention provides a remote control key for remotely controlling a vehicle, including: a lock button configured to remotely lock a door of a vehicle; an unlock button configured to remotely unlock the door of the vehicle; a transmission unit configured to transmit a control signal with a set output; and a key controller configured to control the transmission unit based on an operation of the lock button and the unlock button, in which the key controller includes one or more microprocessors operated by a set program, the set program being embodied in a non-transitory computer readable medium, and the set program includes a series of commands for performing a method of remotely controlling a vehicle.

Still another exemplary embodiment of the present invention provides a method of remotely controlling opening or closing of an additional control target in addition to a door of a vehicle by a radio signal received through a remote control key provided with a lock button for remotely locking a door of the vehicle and an unlock button for remotely unlocking the door of the vehicle, the method including: receiving a radio signal from the remote control key; interpreting a unique identification code included in the radio signal; controlling a door lock or unlock motor for a corresponding operation when the unique identification code is related to opening or closing of the door; and performing a corresponding operation of a corresponding additional control target when the unique identification code is related to opening or closing of the additional control target.

Still yet another exemplary embodiment of the present invention provides a system for remotely controlling a vehicle, including: a remote control key including: a lock button configured to remotely lock a door of a vehicle and an unlock button configured to remotely unlock the door of the vehicle; a transmission unit configured to transmit a control signal with a designated output; and a key controller configured to control the transmission unit based on an operation of the lock button and the unlock button; and a vehicle controller including: a receiving unit configured to receive a radio signal from the remote control key; an actuator configured to operate opening or closing of an additional control target of the vehicle; and a remote control module configured to control the actuator based on the radio signal received from the receiving unit, the vehicle controller being mounted to the vehicle, in which the key controller and the vehicle controller are operated by a set program embodied in a non-transitory computer readable medium for performing the method according to an exemplary embodiment of the present invention.

The remote control key may include: an operation time check unit configured to check and calculate an operation time of the lock button and an operation time of the unlock button; a long-distance radio signal output unit configured to set an output of the radio signal so as to transmit the output of the radio signal to a set long distance when the operation time calculated by the operation time check unit is shorter than a set time; a short-distance radio signal output unit configured to set an output of the radio signal so as to transmit the output of the radio signal to a set short distance shorter than the set long distance when the operation time calculated by the operation time check unit is equal to or longer than a set time; and a microprocessor configured to control a general operation of the remote control key.

The remote control key may further include a radio signal output adjusting unit configured to vary a size of the output of the radio signal output from the long-distance radio signal output unit or the short-distance radio signal output unit.

The remote control key may further include a radio signal selection unit configured to select one radio signal among radio signals output from the long-distance radio signal output unit and the short-distance radio signal output unit to output the selected radio signal.

The vehicle controller may include: a radio signal receiving unit configured to receive the radio signal transmitted from the remote control key; a microprocessor configured to generate a signal for controlling the control target based on the radio signal received in the radio signal receiving unit; and a control target driving unit configured to drive the control target according to the signal generated in the microprocessor.

As described above, according to exemplary embodiments of the present invention, it is possible to satisfy regulations applied to a system for remotely controlling a vehicle in a cost-effective manner by variably controlling an output of a transmission radio signal according to an operation mode so as to transmit the output of the transmission radio signal up to a minimum control distance (long distance) (for example, a minimum of 30 m) at which a door can be locked or unlocked or to transmit the output of the transmission radio signal only up to a maximum control distance (short distance) (for example, a maximum of 7 to 10 m) at which opening or closing of a window and a sunroof that is subject to safety regulations can be controlled.

### BRIEF DESCRIPTION OF THE DRAWINGS

FIG. 1 is a block diagram of a remote control key of a vehicle remote control system according to an exemplary embodiment of the present invention.

FIG. 2 is an exterior perspective view of a remote control key of a vehicle remote control system according to an exemplary embodiment of the present invention.

FIG. 3 is a block diagram of a remote control module of a vehicle remote control system according to an exemplary embodiment of the present invention.

FIG. 4 is a diagram illustrating a control distance of a vehicle remote control system according to an exemplary embodiment of the present invention.

FIG. 5 is a flowchart of a vehicle remote control method according to an exemplary embodiment of the present invention.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

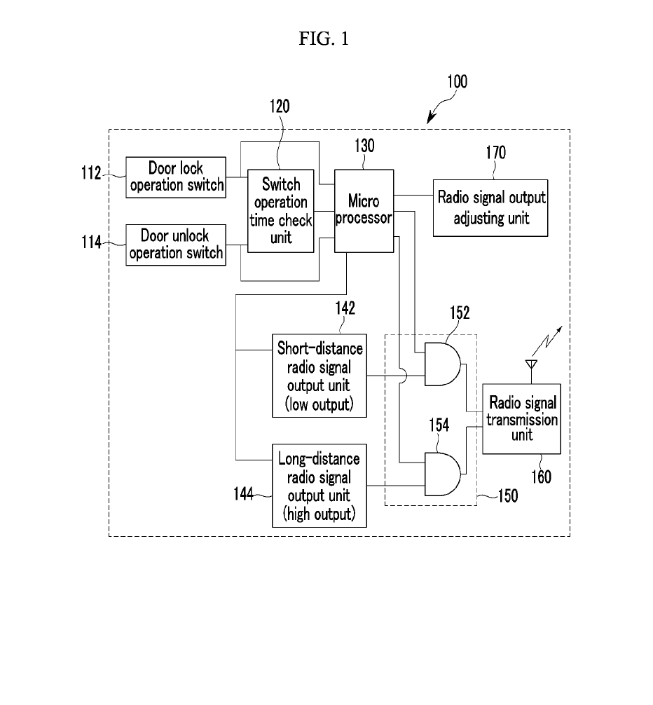

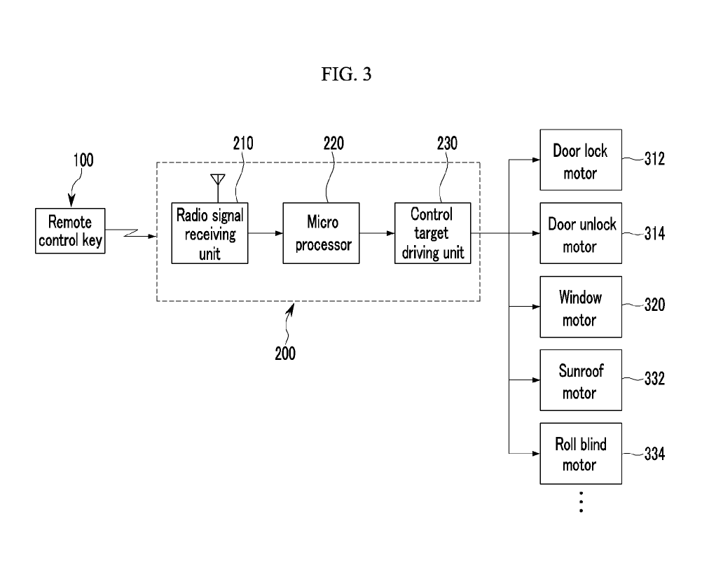

FIG. 1 is a block diagram of a remote control key of a vehicle remote control system according to an exemplary embodiment of the present invention, and FIG. 3 is a block diagram of a remote control module of a vehicle remote control system according to an exemplary embodiment of the present invention.

As illustrated in FIGS. 1 and 3, the remote control key of the vehicle remote control system according to an exemplary embodiment of the present invention includes a remote control key possessed by a user (driver) and a remote control controller or module installed in a vehicle to control driving of a remote control target (a door, a window, a sunroof, or other remote control target) by wirelessly communicating with the remote control key.

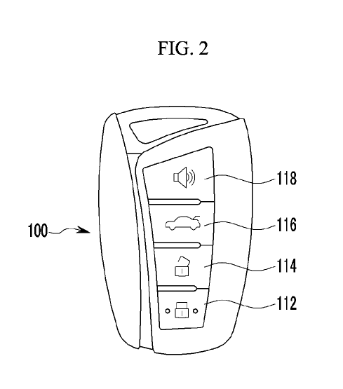

The remote control key 100 of the vehicle remote control system according to an exemplary embodiment of the present invention includes a door locking operation switch 112 for remotely locking a vehicle door and a door unlocking switch 114 for unlocking the vehicle door. The door locking operation switch 112 and the door unlocking switch 114 are displayed as switch buttons in an exterior of the remote control key 100 as illustrated in FIG. 2.

In FIG. 2, a switch button 116 is a switch button for controlling opening or closing of a trunk, and a switch button 118 is a switch button for controlling an operation of a horn.

As described herein, the door locking operation switch 112 and the door unlocking switch 114 are configured to lock or unlock the door, but it will be apparent to those skilled in the art that the door may be opened and closed by operating a door lock motor 312 and a door unlock motor 314. Accordingly, when a door, a window, and a sunroof are mentioned as control targets in describing an exemplary embodiment of the present invention, it should be understood that those expressions generally refer to motors operating the door, the window, and the sunroof, respectively.

In an exemplary embodiment of the present invention, it is described that the control target includes the door, the window, and the sunroof, but it should be understood that the scope of the present invention is not limited thereto. If a particular control target has its remote control distance governed by safety regulations and may be remotely controlled by the remote control key and the remote control module of the present invention, the technical spirit of the present invention may be applied to such a control target, even if not specifically described herein.

As illustrated in FIG. 1, the remote control key 100 according to an exemplary embodiment of the present invention includes: a microprocessor 130 for controlling a general operation of the remote control key 100; a switch operation time check unit 120 for checking and calculating an operation time of the door lock button switch 112 and an operation time of the door unlock button switch 114; a long-distance radio signal output unit 144 for setting an output of a radio signal so that the output of the radio signal may be received within a set minimum long distance (for example, a minimum of about 30 m) according to the control of the microprocessor 130 when the operation time calculated by the switch operation time check unit 120 is shorter than a set time; a short-distance radio signal output unit 142 for setting an output of a radio signal so that the output of the radio signal may be received only within a set maximum short distance (for example, a maximum of about 7 to 10 m) according to the control of the microprocessor 130 when the operation time calculated by the switch operation time check unit 120 is equal to or longer than the set time; a radio signal output adjusting unit 170 for varying an output size of the radio signal output from the long-distance radio signal output unit 144 or the short-distance radio signal output unit 142 under the control of the microprocessor 130 according to a necessity; a radio signal selection unit 150 for selecting only one radio signal among the radio signals output from the long-distance radio signal output unit 144 and the short-distance radio signal output unit 142 and including AND gates 142 and 154; and a radio signal transmission unit 160 for transmitting a radio signal passing through the radio signal selection unit 150 to the outside, as well as the door locking operation switch 112 and the door unlocking switch 114.

The radio signal output adjusting unit 170 includes variable resistance or a switch that may be operated by a user, and when the user operates the variable resistance or the switch, the micro processor 130 senses the operation to vary the output of the radio signal output from the short-distance radio signal output unit 142 to, for example, about 7 m or 10 m. One of ordinary skill in the art would understand that the minimum long distance can be set to any suitable distance, for example, one that is greater or less than about 30 m, depending on a particular embodiment of the present invention. Further, the maximum short distance can be set to any appropriate range that may be different than the above-described range of about 7 m to 10 m, which range may depend on applicable safety regulations.

As illustrated in FIG. 3, the remote control module 200 of the vehicle remote control system according to an exemplary embodiment of the present invention may include: a radio signal receiver (radio signal receiving unit) 210 for receiving the radio signal transmitted from the remote control key 100; a remote control module microprocessor 220 for generating a signal for controlling the control target based on the radio signal received from the radio signal receiving unit 210; and a control target driving unit 230 for driving the control target according to the signal generated in the remote control module microprocessor 220.

The remote control key 100 and the remote control module 200 preferably incorporate hardware and/or software operated by a set program, which is embodied in a non-transitory computer readable medium, and the set program includes programming instructions such as a series of commands for performing a vehicle remote control method according to an exemplary embodiment of the present invention.

In an exemplary embodiment of the present invention, the remote control key 100 and the remote control module 200 preferably include the constituent elements illustrated in FIGS. 1 and 3, where the constituent elements individually or in combination can perform corresponding steps of a vehicle remote control method according to an exemplary embodiment of the present invention.

Hereinafter, a vehicle remote control method according to an exemplary embodiment of the present invention will be described with reference to the accompanying drawings.

The vehicle remote control method according to an exemplary embodiment of the present invention is configured to remotely control even additional control targets such as a window and/or a sunroof, as well as a vehicle door, by using the remote control key 100 provided with the door locking switch 112 for remotely locking the vehicle door and the door unlocking switch 114 for remotely unlocking the vehicle door while satisfying applicable safety regulations.

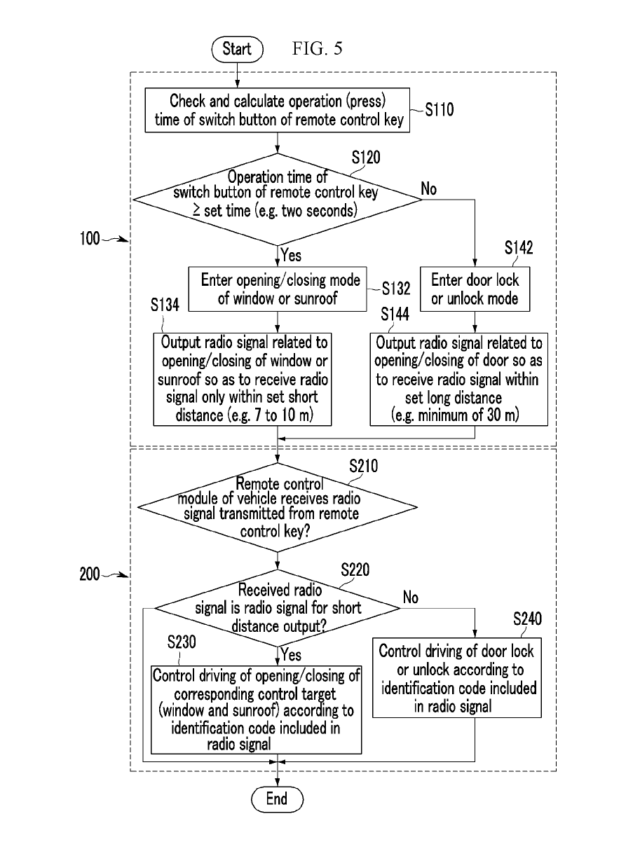

FIG. 5 is a flowchart illustrating the vehicle remote control method according to an exemplary embodiment of the present invention.

As illustrated in FIG. 5, when the user operates the door locking operation switch 112 or the door unlocking switch 114 under the control of the microprocessor 130, the switch operation time check unit 120 of the remote control key 100 checks and calculates the time of the operation (S110).

The check and the calculation of the switch operation time may be easily performed by reading an ON-time of the operation switches 112 and 114 formed with a push button switch or a tack switch. A method of calculating the ON time of operation switches is well known, so that the detailed description thereof will be omitted.

In step S110, when the operation time of the corresponding switches 112 and 114 is calculated, the microprocessor 130 determines whether the calculated operation time is shorter than a set time (for example, two seconds) or equal to or longer than the set time (S 120).

As a result of the determination, when the calculated operation time is shorter than two seconds, the microprocessor 130 controls the long-distance radio signal output unit 144 so as to transmit a radio signal including an unique identification code related to the operation of the corresponding switch with an output of a size transmitted to a minimally set long distance (for example, a minimum of about 30 m) (S142 and S144). The radio signal output from the long-distance radio signal output unit 144 is selected by the AND gate 154 of the radio signal selection unit 150 to be transmitted to the outside through the radio signal transmission unit 160.

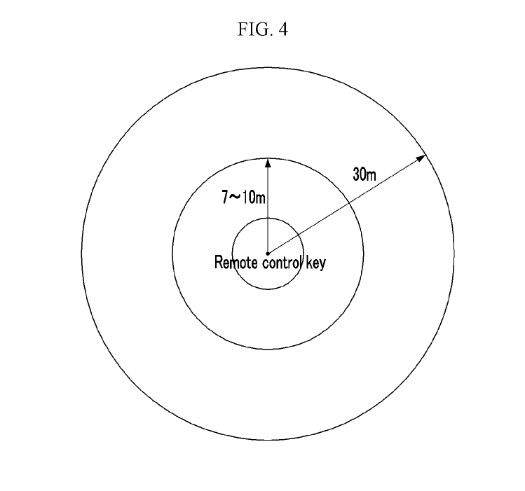

For example, when the user presses the door unlocking switch 114 for a time shorter than two seconds, it means that the user only desires to unlock the door. Accordingly, as illustrated in FIG. 4, when the corresponding vehicle (that is, the vehicle matched with the remote control key) is located in a region within a minimum radius of about 30 m based on the remote control key 100, the microprocessor 220 of the remote control module 200 recognizes the location of the corresponding vehicle through the radio signal receiving unit 210 and makes the control target driving unit 230 operate the door unlock motor 314 so that the door becomes in an unlocked state. Although a distance of about 30 m is set as the minimum long distance, a different distance may be used (for example, about 20 m, 25 m, 35 m, 40 m, or any other suitable distance).

When the user presses the door locking switch 112 for a time shorter than two seconds, a similar process of locking the door is performed.

It may be determined that the operation of the corresponding switches 112 and 114 immediately occurs when the switch button is pressed. However, in an exemplary embodiment of the present invention, in order to discriminate the press of the switch button from the accidental press of the switch button for a short time, a case where the switch button is pressed for a certain time (for example, about 0.7 seconds) or longer may be detected as the operation of the switch.

In an exemplary embodiment of the present invention, an example of a distance for the remote control of the opening or closing of the door is a minimum of about 30 m, but it should be understood that the scope of the present invention is not limited thereto. A different distance, for example, a maximum of 30 m may be set as a distance for the remote control of the opening or closing of the door in terms of a design of the vehicle remote control.

In the meantime, as a result of the determination, when the operation time of the corresponding switches 112 and 114 is equal to or longer than two seconds, the microprocessor 130 controls the short-distance radio signal output unit 142 so as to transmit the radio signal including the unique identification code related to the operation time of the corresponding switch with an output having a size transmitted up to the set short distance (for example, a maximum of about 7 to 10 m) (S132 and S134). The radio signal output from the short distance radio signal output unit 142 is selected by the AND gate 152 of the radio signal selection unit 150 to be transmitted to the outside through the radio signal transmission unit 160.

For example, when the user presses the door locking switch 112 for two seconds or longer, it means that the user desires to close the window and/or the sunroof after locking the door through the operation time shorter than two seconds. Accordingly, as illustrated in FIG. 4, when the corresponding vehicle (that is, the vehicle matched with the remote control key) is located within a maximum radius of about 7 to 10 m based on the remote control key 100, the microprocessor 220 of the remote control module 200 recognizes the location of the corresponding vehicle through the radio signal receiving unit 210 and makes the control target driving unit 230 operate a window motor 320, the sunroof 332, and/or a blind motor 334 as another control target so that the window, the sunroof, and a roll blind are closed.

When the user presses the door unlocking switch 114 for two seconds or longer, a process of opening the window, the sunroof, and the roll blind is similarly performed.

An exemplary embodiment of the method of the present invention includes, as illustrated in FIG. 5, a method S100 performed by the remote control key 100 and a method S200 performed by the remote control module 200.

The method performed by the remote control module 200 will be described below.

When a corresponding radio signal is transmitted to be received in the radio signal receiving unit 210 of the remote control module 200 by the method S100 performed by the remote control key 100, the radio signal receiving unit 210 and the microprocessor 200 analyze a unique identification code included in the received radio signal and identify whether the corresponding radio signal is a radio signal for controlling a specific control target (S210).

A technology for identifying whether the corresponding radio signal is a radio signal for controlling a specific control target by analyzing the unique identification code may be easily implemented through known technology using wireless communication, for example, a conventional door remote control apparatus, so that a detailed description thereof will be omitted.

When the received radio signal is a signal (that is, a long-distance radio signal) for controlling the door lock motor 312 or the door unlock motor 314 as a result of the identification of the unique identification code included in the received radio signal, the microprocessor 200 controls the control target driving unit 230 so as to drive the door lock motor 312 or the door unlock motor 314 so that the door is locked or unlocked (S220 and S240).

Further, when the received radio signal is a signal (that is, a short-distance radio signal) for controlling the window motor 320, the sunroof motor 332, and/or the roll blind motor 334 as a result of the identification of the unique identification code included in the received radio signal, the microprocessor 200 controls the control target driving unit 230 so as to drive the window motor 320, the sunroof motor 332, and/or the roll blind motor 334, so that the window, the sunroof, and/or the roll blind are opened or closed (S220 and S230).

Accordingly, in an exemplary embodiment of the present invention, the output of the radio signal is variably controlled so as to be transmitted to the minimum control distance (long distance) (for example, a minimum of about 30 m) at which the door can be locked or unlocked, or transmitted only up to a maximum control distance (short distance) (for example, a maximum of about 7 to 10 m) at which the window and the sunroof which are the targets for safety regulations can be controlled to be opened or closed, thus it is possible to satisfy the regulations applied to the vehicle remote control system in a cost-effective manner.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: Remote control key
120: Switch operation time check unit
142: Short-distance radio signal output unit
150: Radio signal selection unit
170: Radio signal output adjusting unit
200: Remote control module
210: Radio signal receiving unit
312: Door lock motor

What is claimed is:

1. A method of remotely controlling opening or closing of an additional control target of a vehicle through a remote control key including a function button for remotely controlling a door of the vehicle, the method comprising:
detecting, by a controller, operation of the function button; and
transmitting, by the controller, a signal related to the opening or closing of the additional control target with an output set according to an operation time of the function button.

2. A method of remotely controlling opening or closing of an additional control target in addition to a door of a vehicle through a remote control key provided with a lock button for remotely locking the door of the vehicle and an unlock button for remotely unlocking the door of the vehicle, the method comprising:
detecting, by a controller, an operation of the lock button or the unlock button;
when the operation of the lock button or the unlock button is detected, transmitting, by the controller, a radio signal including a unique identification code related to a door operation corresponding to the operated button among the opening and the closing of the door with a set high output; and
when the manipulation time of the operated lock button or unlock button is equal to or longer than a set time, transmitting, by the controller, the radio signal including the unique identification code corresponding to the operated button in relation to the additional control target with a set low output lower than the set high output.

3. The method of claim 2, wherein:
the set high output is an output having a size by which the radio signal is transmitted to a set long distance.

4. The method of claim 2, wherein:
the set low output is an output by which the radio signal is transmitted to a set short distance shorter than the set long distance.

5. The method of claim 4, wherein:
the set long distance is set to be at least two times larger than the set short distance.

6. The method of claim 2, wherein:
the identification code is related to a close operation of the additional control target when the operated button is the lock button, and
the identification code is related to an open operation of the additional control target when the operated button is the unlock button.

7. The method of claim 2, wherein:
the additional control target is selected from the group consisting of a sunroof, a window, and a roll blind of the vehicle.

8. The method of claim 2, wherein:
the additional control target is selected from the group consisting of a sunroof, a window, and a roll blind of the vehicle,
the set high output is an output having a size by which the radio signal is transmitted to a set long distance, and the set low output is an output by which the radio signal is transmitted to a set short distance shorter than the set long distance, and
the unique identification code corresponding to the operated button is related to a close operation of the additional control target when the operated button is the lock button, and
the unique identification code corresponding to the operated button is related to an open operation of the additional control target when the operated button is the unlock button.

9. A remote control key for remotely controlling a vehicle, comprising:
a lock button configured to remotely lock a door of a vehicle;
an unlock button configured to remotely unlock the door of the vehicle;
a transmission unit configured to transmit a control signal with a set output; and
a key controller configured to control the transmission unit based on an operation of the lock button and the unlock button,
wherein the key controller comprises at least one microprocessor operated by a set program embodied in a non-transitory computer readable medium, and the set program comprises a series of commands for performing a method of remotely controlling a vehicle, the method comprising:
detecting an operation of the lock button or the unlock button;
when the operation of the lock button or the unlock button is detected, transmitting a radio signal including a unique identification code related to a door operation corresponding to the operated button among the opening and the closing of the door with a set high output; and
when an operation time of the operated lock button or unlock button is equal to or longer than a set time, transmitting the radio signal including the unique identification code corresponding to the operated button in relation to the additional control target with a set low output lower than the set high output.

10. A method of remotely controlling opening or closing of an additional control target in addition to a door of a vehicle by a radio signal received through a remote control key provided with a lock button for remotely locking a door of the vehicle and an unlock button for remotely unlocking the door of the vehicle, the method comprising:
receiving a radio signal from the remote control key;
interpreting, by a controller, a unique identification code included in the radio signal;
controlling a door lock or unlock motor for a corresponding operation when the unique identification code is related to opening or closing of the door; and
performing a corresponding operation of a corresponding additional control target when the unique identification code is related to opening or closing of the additional control target.

11. The method of claim 10, wherein:
the additional control target is selected from the group consisting of a sunroof, a window, and a roll blind of the vehicle.

12. The method of claim 11, wherein:
the identification code is related to a close operation of the additional control target when the operated button is the lock button, and
the identification code is related to an open operation of the additional control target when the operated button is the unlock button.

13. A system for remotely controlling a vehicle, comprising:
a remote control key comprising:
a lock button configured to remotely lock a door of the vehicle and an unlock button configured to remotely unlock the door of the vehicle;
a transmission unit configured to transmit a control signal with a designated output; and
a key controller configured to control the transmission unit based on an operation of the lock button and the unlock button; and
a vehicle controller comprising:
a receiving unit configured to receive a radio signal from the remote control key;
an actuator configured to operate opening or closing of an additional control target of the vehicle; and
a remote control module configured to control the actuator based on the radio signal received from the receiving unit, the vehicle controller being mounted to the vehicle,
wherein the key controller is operated by a set program embodied in a non-transitory computer readable medium for performing a method of remotely controlling a vehicle, the method comprising:
detecting an operation of the lock button or the unlock button;
when the operation of the lock button or the unlock button is detected, transmitting a radio signal including a unique identification code related to a door operation corresponding to the operated button among the opening and the closing of the door with a set high output; and
when an operation time of the operated lock button or unlock button is equal to or longer than a set time, transmitting the radio signal including the unique identification code corresponding to the operated button in relation to the additional control target with a set low output lower than the set high output, and
the vehicle controller is operated by the set program for performing the method of remotely controlling a vehicle, the method comprising:
receiving the radio signal from the remote control key;
interpreting, by a controller, the unique identification code included in the radio signal;
controlling a door lock or unlock motor for a corresponding operation when the unique identification code is related to opening or closing of the door; and
performing a corresponding operation of a corresponding additional control target when the unique identification code is related to opening or closing of the additional control target.

14. The system of claim 13, wherein:
the remote control key comprises:
an operation time check unit configured to check and calculate an operation time of the lock button and an operation time of the unlock button;
a long-distance radio signal output unit configured to set an output of the radio signal so as to transmit the output of the radio signal to a set long distance when the operation time calculated by the operation time check unit is shorter than a set time;
a short-distance radio signal output unit configured to set an output of the radio signal so as to transmit the output of the radio signal to a set short distance shorter than the set long distance when the operation time calculated by the operation time check unit is equal to or longer than a set time; and
a microprocessor configured to control a general operation of the remote control key.

15. The system of claim 13, wherein:
the remote control key further comprises:
a radio signal output adjusting unit configured to vary a size of the output of the radio signal output from the long-distance radio signal output unit and the short-distance radio signal output unit.

16. The system of claim 13, wherein:
the remote control key further comprises:
a radio signal selection unit configured to select one radio signal among radio signals output from the long-distance radio signal output unit or the short-distance radio signal output unit and output the selected radio signal.

17. The system of claim 13, wherein:
the vehicle controller comprises:
a radio signal receiving unit configured to receive the radio signal transmitted from the remote control key;
a microprocessor configured to generate a signal for controlling the control target based on the radio signal received in the radio signal receiving unit; and
a control target driving unit configured to drive the control target according to the signal generated in the microprocessor.
